(19) United States
(12) Patent Application Publication
(10) Pub. No.: US 2026/0274175 A1
(43) Pub. Date: Sep. 17, 2026

(54) VEHICLE DISPLAY DEVICE

(71) Applicant: TOYO DENSO KABUSHIKI KAISHA, Tokyo (JP)

(72) Inventors: Atsunori KUSHIDA, Tsurugashima-shi (JP); Naoto OHTSUKA, Tsurugashima-shi (JP); Shinnosuke YAZAKI, Tsurugashima-shi (JP)

(21) Appl. No.: 19/564,581

(22) Filed: Mar. 12, 2026

(30) Foreign Application Priority Data
Mar. 17, 2025 (JP) 2025-042463

(51) Int. Cl. B60R 11/02; B60R 11/00

(52) U.S. Cl. CPC B60R 11/0229; B60R 2011/0084; B60R 2011/0085; B60R 2011/0092

(57) ABSTRACT

A vehicle display device ensuring both an orientation change of a display and movement of the display in the advancing/retracting direction, with a simple structure. A slide portion is disposed so as to be movable in the advancing/retracting direction relative to a base portion, and an urging portion urges the slide portion in the retracting direction. A drive unit in the slide portion rotationally drives the display relative to the slide portion. In conjunction with rotation of the display from a reference position, an abutting portion of the display abutting against an abutted portion of the base portion in the advancing/retracting direction causes the slide portion to move in the advancing direction against an urging force of the urging portion. In conjunction with rotation of the display toward the reference position, the slide portion moves in the retracting direction by an urging force of the urging portion.

### BACKGROUND OF THE INVENTION

### Field of the Invention

The present disclosure relates to vehicle display devices.

### Description of the Related Art

Conventionally, there have been known displays provided in vehicles, the displays being turnable to change their orientation. Displays arranged centrally, for example, in the left-right direction in vehicles have room for improvement in terms of visibility or operability from either a driver's seat or a passenger seat while their position remains fixed.

In view of the above, the techniques disclosed in Japanese Patent No. 6193561 and Japanese Patent No. 3787054 are provided with a function of making the position of a display variable in the front-rear direction and making the orientation of the display variable by panning (swiveling) in the left-right direction.

In the display system disclosed in Japanese Patent No. 6193561, a motor for advancing and retracting the display in the front-rear direction and a motor for panning are separately provided. In the display device disclosed in Japanese Patent No. 3787054, forward/backward movement and pan rotation of the display are realized by a combination of two motors. That is, in the techniques disclosed in Japanese Paten No. 6193561 and Japanese Patent No. 3787054, two motors are used to change the orientation of a display and to move the display in the front-rear direction, and there is room for improvement from the viewpoint of suppressing complication of the configuration.

### SUMMARY OF THE INVENTION

The present disclosure provides vehicle display devices each capable of changing the orientation of a display and moving the display in an advancing/retracting direction with a simple configuration.

A vehicle display device according to one aspect of the disclosure includes a base portion to be fixed to a vehicle, a slide portion movable in an advancing/retracting direction relative to the base portion, and an urging portion that urges the slide portion in the retracting direction relative to the base portion. The vehicle display device further includes a display rotatable about a rotation center relative to the slide portion, and a drive unit that is provided in the slide portion and rotationally drives the display. In conjunction with rotation of the display from a reference position, the abutting portion of the display abutting against the abutted portion of the base portion in the advancing/retracting direction causes the slide portion to move in the advancing direction relative to the base portion, against an urging force of the urging portion. In conjunction with rotation of the display toward the reference position, the slide portion moves in the retracting direction relative to the base portion by an urging force of the urging portion.

The above configuration achieves both display orientation change and display movement in the advancing/retracting direction in a vehicle display device with a simple structure.

Further features of the present invention will become apparent from the following description of exemplary embodiments with reference to the attached drawings.

### BRIEF DESCRIPTION OF THE DRAWINGS

FIG. 1 is a top view of a vehicle display device.

FIG. 2 is a top view of the vehicle display device.

FIG. 3 is a cross-sectional view taken along line III-III of FIG. 1.

FIG. 4 is a front perspective view of the vehicle display device from which a display is omitted.

FIG. 5 is a front perspective view of the vehicle display device from which a base portion and a display are omitted.

FIGS. 6A to 6C are schematic diagrams illustrating a process in which the display rotates in an R1 direction from a reference position, and FIG. 6D is a schematic diagram illustrating a middle of the display rotating in an R2 direction from the reference position.

FIG. 7 is a schematic top view of a vehicle display device according to a modified embodiment.

FIGS. 8A to 8C are schematic diagrams illustrating a process in which the display rotates in the R1 direction from the reference position in the modified embodiment.

FIGS. 9A to 9B are top views of a vehicle display device according to the second embodiment.

FIG. 10 is a diagram illustrating a vehicle display device according to a modified embodiment.

### DESCRIPTION OF THE EMBODIMENTS

Hereinafter, an embodiment of the present disclosure will be described with reference to the drawings.

### First Embodiment

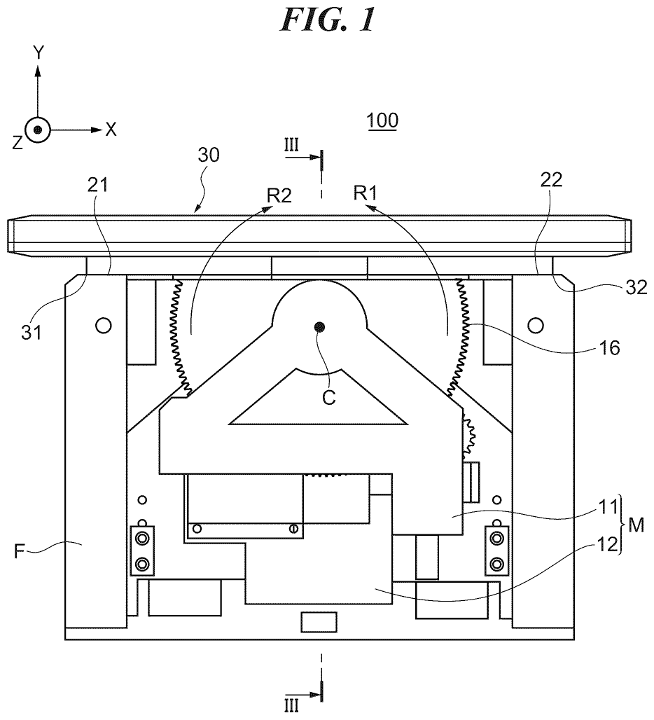

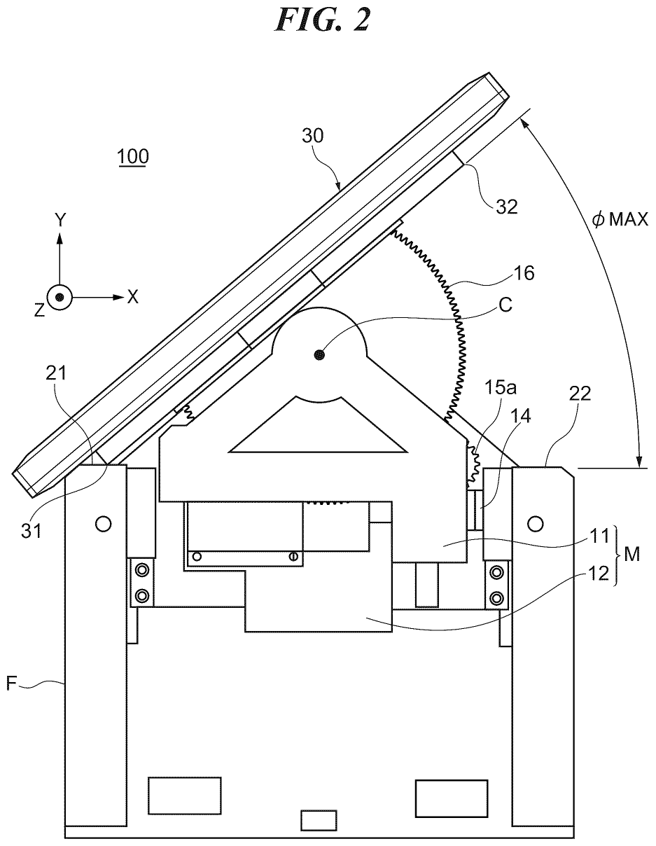

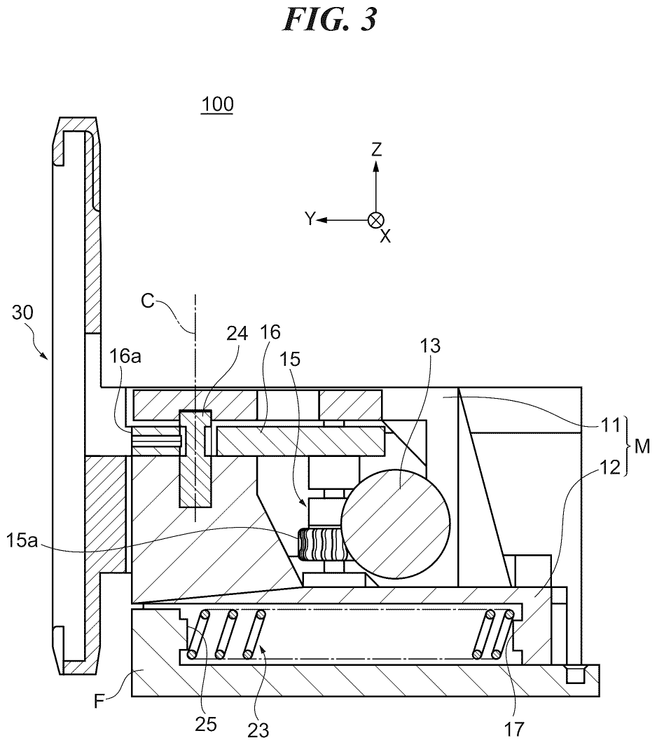

FIGS. 1 and 2 are top views of a vehicle display device according to a first embodiment of the present disclosure. FIG. 3 is a cross-sectional view of the vehicle display device taken along line III-III of FIG. 1.

A vehicle display device 100 is an in-vehicle device mounted on a vehicle, such as an automobile, to be used in an interior of the vehicle. The vehicle display device 100 has, for example, a navigation function, an audio function, and the like, but the functions provided by the vehicle display device 100 are not limited thereto. The vehicle display device 100 includes a display 30 rotatable about a rotation center C.

Hereinafter, the directions of various components will be referred to with reference to the X, Y, and Z coordinate axes illustrated in FIG. 1 and other figures. It is assumed that the axial direction of the rotation center C is the Z direction, with the upper side being the +Z side. The +Y side is the front side, and an occupant normally views the display 30 from the +Y side. The left side is the +X side as viewed from the occupant viewing the display 30.

The vehicle display device 100 basically includes a base portion F and a slide portion M in addition to the display 30. The base portion F is a fixed portion to be fixed to the vehicle. The slide portion M is a movable portion disposed to be movable in the advancing/retracting direction (Y-axis direction) relative to the base portion F. The slide portion M is formed by fixing an upper member 11 and a lower member 12 together. The display 30 is provided so as to be rotatable about the rotation center C relative to the slide portion M.

FIG. 1 illustrates the vehicle display device 100 at a reference position. When viewed from the +Z side, the display 30 is rotatable (or pivotable) in an R1 direction (counterclockwise direction) and an R2 direction (clockwise direction) from the reference position. At the reference position, the display 30 is located in the middle of the rotatable angular range and lies parallel to the X-axis direction. At the reference position, the slide portion M is located at the most negative −Y position within the movable range of the slide portion M in the advancing/retracting direction (Y-axis direction) relative to the base portion F. It should be noted that, at the reference position, it is sufficient that the display 30 is located within the rotatable angular range and is not necessarily at the center of the rotatable angular range.

FIG. 2 illustrates the display 30 rotated by a maximum angle φMAX at which the display 30 is rotatable in the R1 direction. The R1 direction is a direction in which the display 30 faces right and the R2 direction is a direction in which the display 30 faces left, as seen from an occupant. FIG. 2 further illustrates the slide portion M moved in the advancing direction (+Y direction) relative to the base portion F.

In the present embodiment, it should be noted that the advancing/retracting direction of the slide portion M is also referred to as a front-rear direction for convenience, but it is not essential that the advancing/retracting direction coincides with the front-rear direction of the vehicle. The advancing/retracting direction is determined by an orientation or an angle of the vehicle display device 100.

On the −Y-side end face of the display 30 at the reference position, the −X-side edge (or apex) is referred to as an edge 31, and the +X-side edge (or apex) is referred to as an edge 32. Among both side portions of the base portion F arranged in the X-axis direction, the +Y-side end face of the −X-side side portion is referred to as a front end face 21, and the +Y-side end face of the +X-side side portion is referred to as a front end face 22. When the display 30 is at the reference position, the edge 31 is in contact with the front end face 21, and the edge 32 is in contact with the front end face 22.

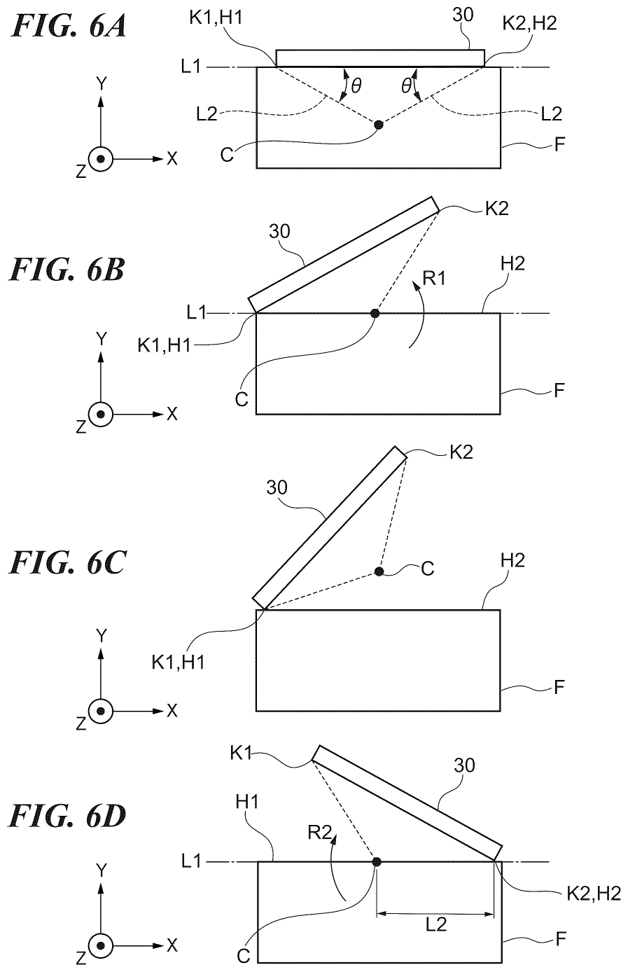

In the process in which the display 30 rotates in the R1 direction, the edge 32 is separated from the front end face 22 while the edge 31 is in contact with the front end face 21 (see FIG. 2). In the process in which the display 30 rotates in the R2 direction, the edge 31 is separated from the front end face 21 while the edge 32 is in contact with the front end face 22. The action in the process in which the display 30 rotates will be described later with reference to FIGS. 6A to 6D.

As illustrated in FIG. 3, the lower member 12 of the slide portion M is provided with a spring receiving portion 17, and the base portion F is provided with a spring receiving portion 25. A space whose longitudinal direction is the Y-axis direction is formed between the spring receiving portion 17 and the spring receiving portion 25, and an urging portion 23 which is a coil spring is disposed in this space in a compressed state. Therefore, the urging portion 23 constantly urges the slide portion M in the retracting direction (−Y direction) relative to the base portion F.

It should be noted that the urging portion that urges the slide portion M in the retracting direction is not limited to the coil spring in the compressed state. A tension spring may be used depending on the positional relationship of the spring receiving portions 17, 25. Alternatively, an elastic member such as rubber other than a spring may be used as the urging portion.

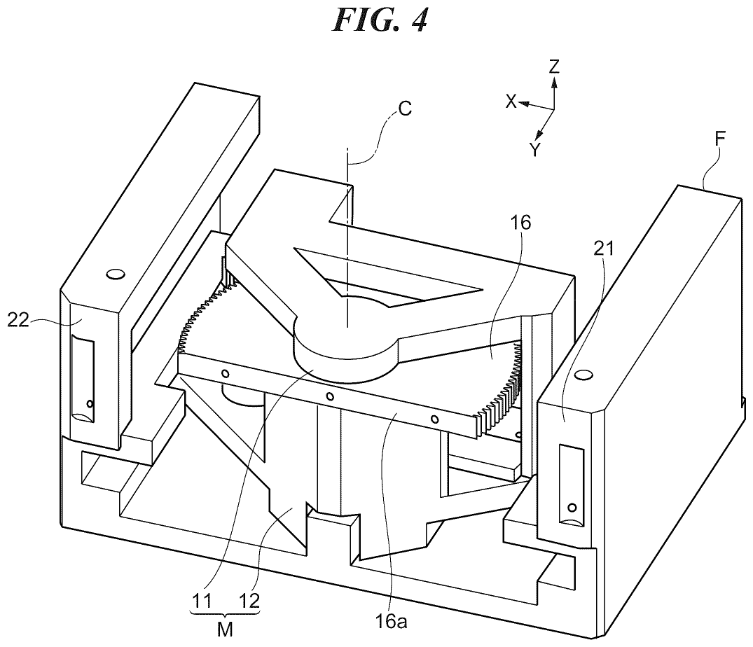

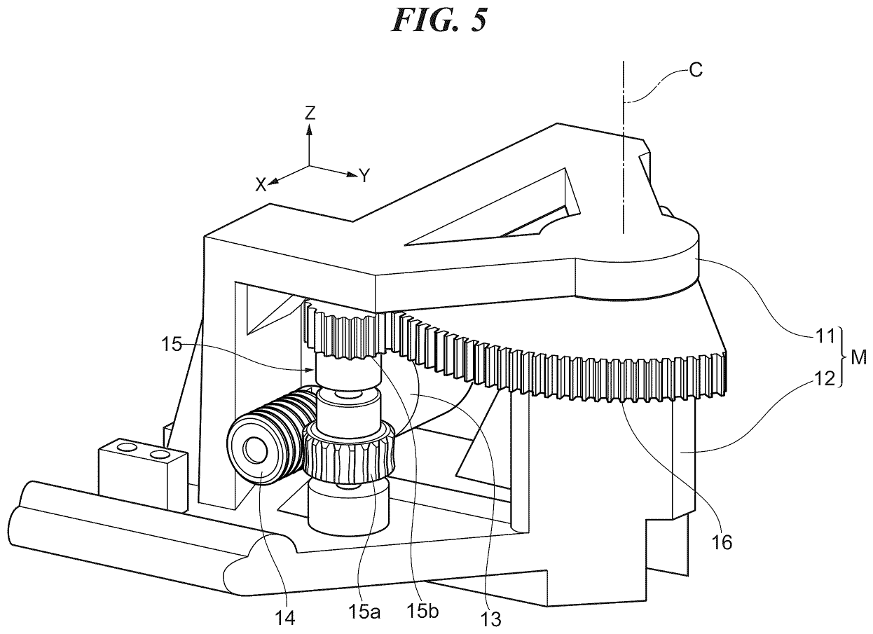

FIG. 4 is a front perspective view of the vehicle display device 100 from which the display 30 is omitted. FIG. 5 is a front perspective view of the vehicle display device 100 from which the base portion F and the display 30 are omitted. The vehicle display device 100 of FIG. 4 corresponds to the vehicle display device 100 at the reference position illustrated in FIG. 1, and the vehicle display device 100 of FIG. 5 corresponds to the vehicle display device 100 in the state in which the display 30 has been rotated by the maximum angle φMAX in the R1 direction illustrated in FIG. 2.

A drive unit 13 is disposed on the lower member 12 of the slide portion M (see FIGS. 3 and 5). The drive unit 13 is, for example, an electric motor. The transmission portion 15 is disposed between the upper member 11 and the lower member 12 (see FIGS. 3 and 5). The transmission portion 15 includes a worm wheel 15a at its lower portion and a spur gear 15b at its upper portion. The transmission portion 15 is rotatable integrally about an axis parallel to the Z axis.

A worm gear 14 protrudes from the drive unit 13 in the +X direction to mesh with the worm wheel 15a of the transmission portion 15 (see FIG. 5). The worm gear 14 rotates integrally with the output shaft of the drive unit 13, and transmits the rotation of the output shaft about the X axis to the worm wheel 15a, so that the rotation of the output shaft is converted into the rotation of the transmission portion 15 about the Z axis.

A display support 16 is disposed between the upper member 11 and the lower member 12. The display support 16 is shaped like a partially cut circular spur gear and has an end face 16a facing the +Y direction when the vehicle display device 100 is at the reference position (see FIGS. 3 and 4). A shaft portion 24 is supported freely rotatable about the Z axis by the upper member 11 and the lower member 12 (see FIG. 3). The central axis of the shaft portion 24 coincides with the rotation center C.

The display support 16 is rotatable integrally with the shaft portion 24. The spur gear 15b of the transmission portion 15 meshes with the gear of the display support 16. Therefore, the rotation of the spur gear 15b is transmitted to the display support 16. As a result, the rotation of drive unit 13 is transmitted to the display support 16 via the transmission portion 15, causing the display support 16 to rotate about the rotation center C.

The display 30 is fixed to the end face 16a of the display support 16 with a screw or the like. This makes the display 30 rotatable integrally with the display support 16. It should be noted that the drive unit 13 may operate on the basis of an operation instruction from an occupant or may operate in accordance with an instruction from a control unit which is not illustrated.

The movement of the slide portion M in the X-axis direction is restricted by the base portion F. This makes the slide portion M slidable only in the Y-axis direction. The display 30 is also movable in the Y-axis direction integrally with the slide portion M.

In the present embodiment, the force for moving the slide portion M in the advancing direction is generated by rotation of the display 30. In particular, when the display 30 rotates in the R1 direction from the reference position, the slide portion M moves in the advancing direction due to the abutment of the edge 31 against the front end face 21. When the display 30 rotates in the R2 direction from the reference position, the slide portion M moves in the advancing direction due to the abutment of the edge 32 against the front end face 22. This will be described with reference to FIGS. 6A to 6D.

FIGS. 6A to 6C are schematic diagrams illustrating a process in which the display 30 rotates in the R1 direction from the reference position. FIG. 6D is a schematic diagram illustrating a middle of the display 30 rotating in the R2 direction from the reference position. In FIGS. 6A to 6D, for easy understanding, the display 30, the base portion F, and the rotation center C are schematically illustrated, and the slide portion M is omitted.

The base portion F includes a first abutted portion H1 and a second abutted portion H2 as abutted portions. The display 30 includes a first abutting portion K1 and a second abutting portion K2 as abutting portions respectively corresponding to the first abutted portion H1 and the second abutted portion H2. The edge 31 in FIG. 2 corresponds to the first abutting portion K1, and the edge 32 in FIG. 2 corresponds to the second abutting portion K2. As illustrated in FIG. 6A, when the display 30 is at the reference position, the first abutting portion K1 and the second abutting portion K2 are located on both sides of the rotation center C in the X-axis direction which is a first direction orthogonal to the axial direction of the rotation center C and the advancing/retracting direction. At the reference position, the display 30 abuts against the base portion F at both the first abutting portion K1 and the second abutting portion K2.

The first abutted portion H1 of the base portion F is a portion of the front end face 21 that abuts against the first abutting portion K1. The second abutted portion H2 is a portion of the front end face 22 that abuts against the second abutting portion K2. The position of the first abutted portion H1 on the front end face 21 changes during the rotation stroke of the display 30. The position of the second abutted portion H2 on the front end face 22 changes during the rotation stroke of the display 30.

With reference to FIGS. 6A to 6C, the rotation of the display 30 in the R1 direction from the reference position will be described. The display 30 is at the reference position in FIG. 6A, is in the middle of the rotation in FIG. 6B, and is in a position rotated by the maximum angle φMAX in FIG. 6C.

In conjunction with the rotation of the display 30 in the R1 direction from the reference position, the first abutting portion K1 abuts against the first abutted portion H1 in the advancing/retracting direction. This causes the slide portion M to move in the advancing direction relative to the base portion F, against the urging force of the urging portion 23.

When the display 30 rotates back toward the reference position from the middle of rotation in the direction R1 or from the position rotated by the maximum angle φMAX, the operation of the display 30 transitions in the order of FIGS. 6C, 6B, and 6A. That is, in conjunction with the rotation of the display 30 toward the reference position, the urging force of the urging portion 23 causes the slide portion M to move in the retracting direction relative to the base portion F, with the first abutting portion K1 abutting against the first abutted portion H1.

The operation of the display 30 rotating in the R2 direction from the reference position can be understood by inverting, about the Y axis, the operation of the display 30 rotating in the R1 direction.

As illustrated in FIG. 6D, in conjunction with the rotation of the display 30 in the R2 direction from the reference position, the second abutting portion K2 abuts against the second abutted portion H2 in the advancing/retracting direction. This causes the slide portion M to move in the advancing direction relative to the base portion F, against the urging force of the urging portion 23.

Meanwhile, the operation of the display 30 rotating back toward the reference position from the middle of the rotation in the R2 direction or from the position rotated by maximum angle φMAX can be understood similarly to the operation of the display 30 in the case of the rotation of the display 30 in the R1 direction.

Next, the formation angle θ will be described. As illustrated in FIG. 6A, when the display 30 is at the reference position, a first virtual straight line L1 and a second virtual straight line L2 run on a virtual first plane that includes the first abutting portion K1 and the second abutting portion K2 and is orthogonal to the Z-axis. A straight line passing through the first abutting portion K1 and the second abutting portion K2 on the virtual first plane is referred to as the first virtual straight line L1. A straight line passing through the first abutting portion K1 (or the second abutting portion K2) and the rotation center C on the virtual first plane is referred to as the second virtual straight line L2. In this case, an acute angle formed between the first virtual straight line L1 and the second virtual straight line L2 is defined as a formation angle θ.

The formation angle θ is a parameter representing a positional relationship between the display 30 and the rotation center C. It should be noted that the formation angle θ on the first abutting portion K1 side and the formation angle θ on the second abutting portion K2 side are basically the same angle, but this is not essential. It should be noted that the formation angle θ may be defined as an angle between the first virtual straight line L1 and the second virtual straight line L2 formed on a side where the rotation center C lies relative to a straight line that passes through the first abutting portion K1 (or the second abutting portion K2) and is parallel to the Y-axis direction, when the display 30 is at the reference position. It is assumed that the formation angle θ formed when the rotation center C is located in the retracting direction relative to the first virtual straight line L1 is positive.

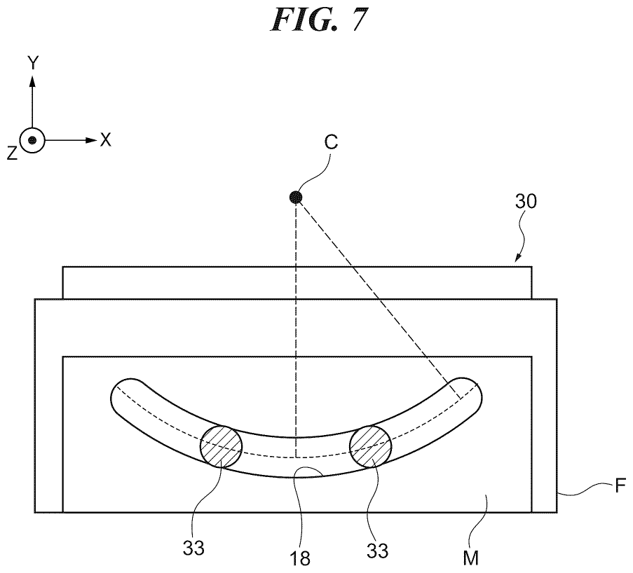

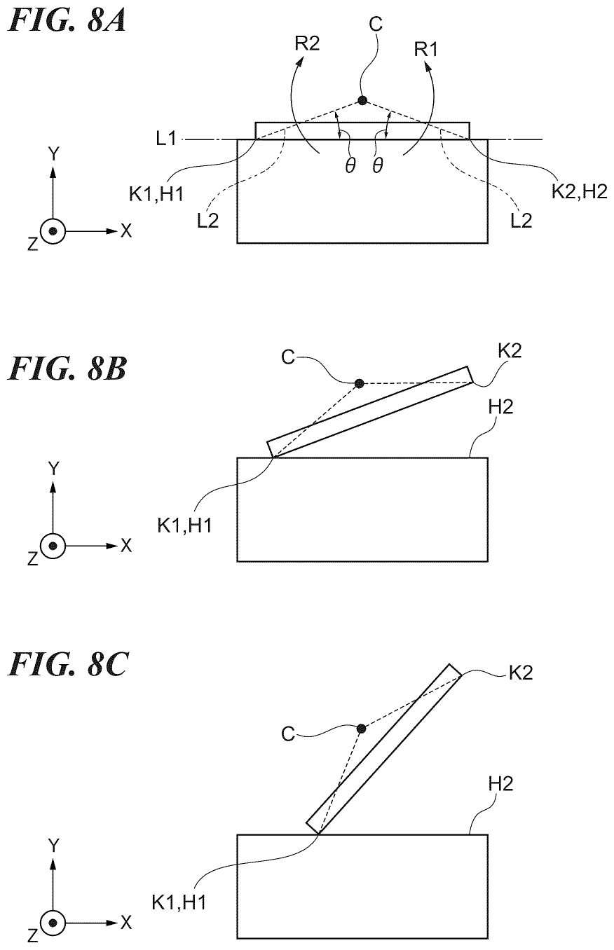

As described with reference to FIGS. 7 and 8A to 8C, it should be noted that the vehicle display device 100 may employ an imaginary rotation axis provided by locating the rotation center C on the +Y side of the display 30.

FIG. 7 is a schematic top view of a vehicle display device according to a modification of the present embodiment. The slide portion M is slidable in the Y-axis direction relative to the base portion F. An arc groove 18 is formed in the slide portion M. The center of curvature of the arc groove 18 is the rotation center C. A plurality of engagement pins 33 are provided to protrude in the +Z direction at a portion fixed to the display 30. The engagement pins 33 engage with the arc groove 18. Other configurations are similar to those described in FIGS. 1 to 6D.

When the display 30 rotates about the rotation center C while the engagement pins 33 engage with the arc groove 18, the above-described action of the abutting portion and the abutted portion causes the slide portion M to move in the advancing direction in conjunction with the rotation of the display 30.

FIGS. 8A to 8C are schematic diagrams illustrating a process in which the display 30 rotates in the R1 direction from the reference position in the modified embodiment (see FIG. 7). The display 30 is at the reference position in FIG. 8A, is in the middle of the rotation in FIG. 8B, and is in a position rotated by the maximum angle φMAX in FIG. 8C.

The operation of the display 30 rotating back toward the reference position can also be understood in the same manner as described with reference to FIGS. 1 to 6D. In addition, the operation of the display 30 rotating in the R2 direction from the reference position can be understood by inverting, about the Y axis, the operation of the display 30 rotating in the R1 direction.

It is assumed that the formation angle θ formed when the rotation center C is located in the retracting direction relative to the first virtual straight line L1 is positive. Therefore, the formation angle θ is always a negative value in this modified embodiment.

In any of the configurations of FIGS. 1 to 6D and the configurations of FIGS. 7 and 8A to 8C, when the display 30 is rotated, the end of the display 30 facing the X-axis direction protrudes in the X-axis direction as compared with the case where the display 30 is at the reference position. From the viewpoint of suppressing this protrusion, the formation angle θ falls preferably within the range of −15° to +15°. More preferably, the formation angle θ is approximately 0°.

The force for moving the slide portion M in the advancing direction when the display 30 rotates from the reference position is substantially the maximum when the rotation center C is located on the first virtual straight line L1 as illustrated in FIG. 6B. Therefore, from the viewpoint of enhancing the efficiency of the rotation drive of the display 30, the formation angle θ falls preferably within the range of −15° to +15° measured from half the maximum angle φMAX. As a result, a component having a small driving force can be selected as the drive unit 13. More preferably, the formation angle θ is substantially equal to half the maximum angle φMAX.

As an example, when φMAX=40°, half the maximum angle φMAX is 20°. Therefore, the formation angle θ is preferably set to fall within the range of +5° to +35°. For example, when the formation angle θ is set to +10° in the configuration of FIGS. 1 to 6D, it satisfies both “the formation angle θ falls within the range of −15° to +15°” and “the formation angle θ falls within the range of +5° to +35°”.

According to the present embodiment, the abutting portion (K1, K2) abuts against the abutted portion (H1, H2) in the advancing/retracting direction in conjunction with the rotation of the display 30 from the reference position. This causes the slide portion M to move in the advancing direction relative to the base portion F, against the urging force of the urging portion 23. Further, in conjunction with the rotation of the display 30 toward the reference position, the slide portion M moves in the retracting direction relative to the base portion F, by the urging force of the urging portion 23. As a result, it is not necessary to provide two drive units to achieve both display orientation change and display movement in the advancing/retracting direction. Therefore, it is possible to achieve both the display orientation change and the display movement in the advancing/retracting direction with a simple configuration.

### Second Embodiment

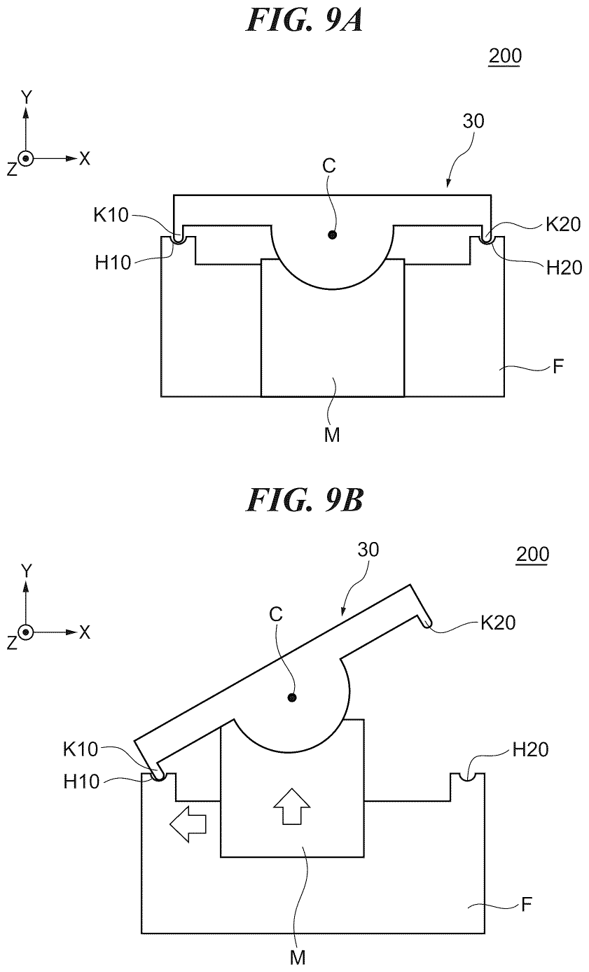

FIGS. 9A and 9B are top views of a vehicle display device 200 according to a second embodiment of the present disclosure. The basic configuration of the vehicle display device 200 is similar to that of the first embodiment (see FIG. 1), but is mainly different in that the slide portion M is movable also in the X-axis direction relative to the base portion F. The display 30 is at the reference position in FIG. 9A, and is in the middle of rotation or at the rotation end position in FIG. 9B.

In the present embodiment, the slide portion M is supported so as to be slidable in the X-axis direction and the Y-axis direction relative to the base portion F without rotating. As an example, the slide portion M is configured such that a second member movable only in the Y-axis direction is supported by a first member movable only in the X-axis direction. The display 30 is rotatably supported by the second member about the rotation center C.

Instead of the first abutting portion K1, the second abutting portion K2, the first abutted portion H1, and the second abutted portion H2 in the first embodiment, a first abutting portion K10, a second abutting portion K20, a first abutted portion H10, and a second abutted portion H20 are provided in the present embodiment. The first abutting portion K10 and the second abutting portion K20 are convex portions protruding toward the −Y side when the display 30 is at the reference position, and the first abutted portion H10 and the second abutted portion H20 corresponding thereto are concave portions recessed toward the −Y side.

The abutting portion (K10, K20) engages with the abutted portion (H10, H20) in the X-axis direction in conjunction with the rotation of the display 30, and thus, the movement of the abutting portion (K10, K20) in the X-axis direction is restricted. As a result, the slide portion M moves relative to the base portion F in the Y-axis direction and also moves in the X-axis direction.

The positions of the slide portion M in the Y-axis direction and the X-axis direction are determined by the rotation angle of the display 30. That is, the position of the slide portion M is determined by the positional relationship between the rotation center C and the engagement position of the abutting portion K10, K20 and the abutted portion H10, H20.

For example, focusing on the rotation in the R1 direction, during the rotation stroke of the slide portion M, the engagement position of the first abutting portion K10 and the first abutted portion H10 in the X-axis direction is substantially unchanged, but the rotation center C moves in the X-axis direction (−X direction), too. Therefore, the slide portion M moves in the +Y direction and the −X direction relative to the reference position (FIG. 9B).

As described above, since the engagement position of the abutting portion (K10, K20) and the abutted portion (H10, H20) in the X-axis direction do not substantially change, the protruding amount of the display 30 in the X-axis direction becomes smaller than that in the first embodiment.

In the vehicle display device 100 in which the position of the abutted portion H1, H2 in the X-axis direction changes during the rotation stroke (see FIG. 1 and FIGS. 8A to 8C), the protruding amount of the display 30 in the X-axis direction varies depending on the setting of the formation angle θ. However, by adopting the configuration of the present embodiment, the effect of suppressing the protrusion of the display 30 in the X-axis direction can be expected regardless of the setting of the formation angle θ.

According to the present embodiment, it is possible to achieve the same effects as those of the first embodiment with respect to achieving both display orientation change and display movement in the advancing/retracting direction with a simple configuration. Further, it is possible to suppress the protrusion of the display 30 in the X-axis direction.

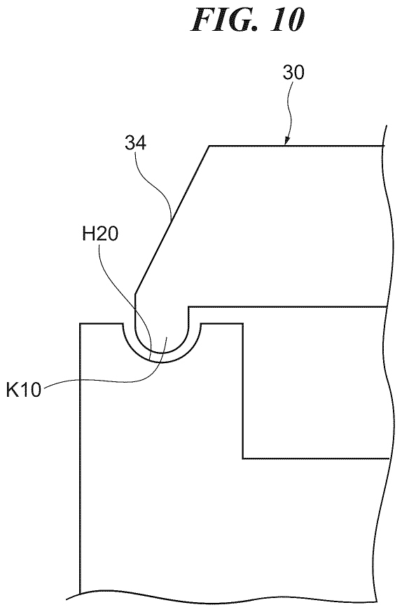

Also in the present embodiment, it should be noted that the position on the +Y-side edge of the end in the X-axis direction of the display 30 easily protrudes in the X-axis direction. Therefore, as illustrated in a modified embodiment in FIG. 10, cutouts 34 may be provided at the +Y-side edges of the both ends in the X-axis direction of the display 30 to suppress protrusion in the X-axis direction. This cutout 34 may also be applied to the first embodiment.

In each of the above embodiments, the display 30 is configured to be rotatable in both directions of R1 and R2 from the reference position. However, the display 30 is not limited thereto, and may be configured to be rotatable only in one direction from the reference position.

Although the present disclosure has been described in detail based on preferred embodiments thereof, the present disclosure is not limited to these specific embodiments, and various forms without departing from the gist of the present technology are also included in the present technology. Some of the above-described embodiments may be appropriately combined.

This application claims the benefit of Japanese Patent Application No. 2025-042463 filed on Mar. 17, 2025 which is hereby incorporated by reference herein in its entirety.

What is claimed is:

1. A vehicle display device comprising:
a base portion to be fixed to a vehicle;
a slide portion movable in an advancing/retracting direction relative to the base portion;
an urging portion that urges the slide portion in the retracting direction relative to the base portion;
a display rotatable about a rotation center relative to the slide portion; and
a drive unit that is provided in the slide portion and rotationally drives the display,
wherein the display includes an abutting portion and the base portion includes an abutted portion, and
wherein in conjunction with rotation of the display from a reference position, the abutting portion of the display abutting against the abutted portion of the base portion in the advancing/retracting direction causes the slide portion to move in the advancing direction relative to the base portion, against an urging force of the urging portion, and
in conjunction with rotation of the display toward the reference position, the slide portion moves in the retracting direction relative to the base portion by an urging force of the urging portion.

2. The vehicle display device according to claim 1,
wherein the reference position is a position at which the display is parallel to a first direction orthogonal to an axial direction of the rotation center and to the advancing/retracting direction,
the abutting portion includes a first abutting portion and a second abutting portion located on both sides of the rotation center in the first direction when the display is at the reference position,
the display at the reference position abuts against the base portion at both of the first abutting portion and the second abutting portion, and
when the display at the reference position forms a formation angle, which is an acute angle between a first virtual straight line and a second virtual straight line, on a virtual first plane orthogonal to the axial direction of the rotation center, the first virtual straight line passing through the first abutting portion and the second abutting portion, the second virtual straight line passing through the first abutting portion and the rotation center, and the formation angle being positive in a case where the rotation center is located in the retracting direction relative to the first virtual straight line, the formation angle falls within a range of −15° to +15°.

3. The vehicle display device according to claim 1,
wherein the reference position is a position at which the display is parallel to a first direction orthogonal to an axial direction of the rotation center and to the advancing/retracting direction,
the abutting portion includes a first abutting portion and a second abutting portion located on both sides of the rotation center in the first direction when the display is at the reference position,
the display at the reference position abuts against the base portion at both of the first abutting portion and the second abutting portion, and
when the display at the reference position forms a formation angle, which is an acute angle between a first virtual straight line and a second virtual straight line, on a virtual first plane orthogonal to the axial direction of the rotation center, the first virtual straight line passing through the first abutting portion and the second abutting portion, the second virtual straight line passing through the first abutting portion and the rotation center, and the formation angle being positive in a case where the rotation center is located in the retracting direction relative to the first virtual straight line, the formation angle is within a range of −15° to +15° measured from half a maximum angle by which the display is rotatable from the reference position.

4. The vehicle display device according to claim 1,
wherein the slide portion is further movable relative to the base portion in a first direction orthogonal to an axial direction of the rotation center and to the advancing/retracting direction, and
in conjunction with rotation of the display, the abutting portion engaging with the abutted portion in the first direction restricts movement of the abutting portion in the first direction, causing the slide portion to move in the advancing/retracting direction relative to the base portion and to move in the first direction.

5. The vehicle display device according to claim 2,
wherein the slide portion is further movable relative to the base portion in a first direction orthogonal to an axial direction of the rotation center and to the advancing/retracting direction, and
in conjunction with rotation of the display, the abutting portion engaging with the abutted portion in the first direction restricts movement of the abutting portion in the first direction, causing the slide portion to move in the advancing/retracting direction relative to the base portion and to move in the first direction.

6. The vehicle display device according to claim 3,
wherein the slide portion is further movable relative to the base portion in a first direction orthogonal to an axial direction of the rotation center and to the advancing/retracting direction, and
in conjunction with rotation of the display, the abutting portion engaging with the abutted portion in the first direction restricts movement of the abutting portion in the first direction, causing the slide portion to move in the advancing/retracting direction relative to the base portion and to move in the first direction.
